(19) United States
(12) Patent Application Publication
(10) Pub. No.: US 2016/0343157 A1
(43) Pub. Date: Nov. 24, 2016

(54) Template And Method For Predesigning And Installing Items On A Wall

(71) Applicants: Karyn Riggione, Loudonville, NY (US); Dorina Vallaj, Clifton Park, NY (US); Sonila Plaku, Clifton Park, NY (US)

(72) Inventors: Karyn Riggione, Loudonville, NY (US); Dorina Vallaj, Clifton Park, NY (US); Sonila Plaku, Clifton Park, NY (US)

(21) Appl. No.: 15/157,950

(22) Filed: May 18, 2016

Related U.S. Application Data
(60) Provisional application No. 62/163,099, filed on May 18, 2015.

(51) Int. Cl. G06T 11/60; A47G 1/06

(52) U.S. Cl. CPC G06T 11/60; A47G 1/065; A47G 2001/0694; G06T 2210/04

(57) ABSTRACT

A collage system and method enables creative predesign and arrangement of at least one item to form a collage. A plurality of predesign media enables digital predesign through dimensional and positional manipulation of at least one design boundary. The design boundary is the place holder for the at least one item. One of the predesign media is selected as the desired collage arrangement. The selected predesign medium is converted into a template surface that is printed with design boundaries that match the arrangement of design boundaries manipulated in the predesign medium. The template surface comprises horizontal and vertical lines that enable aligned positioning of at least one item inside an interior region of the design boundary. The template surface is mounted on a mounting surface. The mounting surface comprises a leveling line for appropriate alignment and mounting of the template surface. A frame encloses the item for visual enhancement.

### CROSS REFERENCE OF RELATED APPLICATIONS

This application claims the benefits of U.S. provisional application No. 62/163,099, filed May 18, 2015 and entitled TEMPLATE AND METHOD FOR PREDESIGNING AND INSTALLING ITEMS ON A WALL, which provisional application is incorporated by reference herein in its entirety.

### FIELD OF THE INVENTION

The present invention relates generally to a collage system and method for creative predesign and arrangement of items on a surface to form a decorative layout. More so, the collage system and method for predesign and arrangement of items on a surface enables systematic predesign of a collage on a predesign medium, such as a digital display screen; conversion of the predesigned medium to a template surface, such as a prefabricated panel; arrangement of at least one item on the template surface in conformance with the predesign; framing of the item; and mounting of the template surface on a mounting surface to form the predesigned collage or decorative layout.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known in the art that a collage is a plurality of art objects mounted in a pleasing relationship to each other upon a background material. The art objects are generally glued, or fixedly attached in place on a background material and hence could not be rearranged or replaced. The individual art objects, thus create a new whole.

Typically, the art objects used in the collage consist of decorative media, such as magazine and newspaper clippings, ribbons, paint, bits of colored or handmade papers, portions of other artwork or texts, photographs and other found objects, glued to a piece of paper or canvas. The arrangement of decorative media generally occurs after the mounting surface is ready to receive the items.

In many instances, digital image editing computer programs are prevalent and easily accessible and provide a means that allows any computer to be used for digital image editing. Such image editing computer programs enable users to store, organize, manage, edit, enhance, and share digital images at the central network location using a web browser or other software applications. A user can also design and personalize image-based products.

Digital manipulation allows for predesigning templates prior to actual printing or construction of a substrate or surface. Thus, the finished product can be viewed digitally prior to expensing the resources to produce the visual product, such as a collage.

Other proposals have involved designing decorative layouts and collages. The problem with these techniques is that they do not allow for predesigning and adjusting dimensions and positions of the decorative items, prior to forming the collage. Even though the above cited design techniques meet some of the needs of the market, a collage system and method for creative predesign and arrangement of items on a surface enables systematic predesign of a collage on a predesign medium; then conversion of the predesigned medium to a template surface; then arrangement of items on the template surface in conformance with the predesign; and finally framing and mounting of the completed template surface on a mounting surface as a collage or decorative layout is still desired.

### SUMMARY

Illustrative embodiments of the disclosure are generally directed to a collage system and method for predesign and arrangement of items on a surface. The collage system and method enables systematic predesign of a collage on a selected predesign medium, such as a display screen through software, and then arrangement of at least one item on a template surface, such as a prefabricated panel. The design of the template surface follows substantially the same configuration as the predesign medium. At least one item fastens to the template surface in conformance with the predesigned layout. The item may be framed for visual enhancement. The template surface may then be mounted on a mounting surface to form the collage or decorative layout.

In one embodiment, the collage system and method enables creative predesign and arrangement of at least one item on a predesigned arrangement, so as to form a collage, or other decorative layout. The collage system and method may provide a plurality of predesign media that facilitate dimensional and positional manipulation of at least one design boundary that represents a visual depiction of at least one item that forms the finished collage. The design boundary is essentially the place holder for the item. In one embodiment, the predesign media is operated digitally on a display screen.

From the plurality of predesign media, one predesign medium is selected to be converted into the template surface. The template surface may be marked to have at least one design boundary that substantially matches the dimension and position of the at least one design boundary that was manipulated in the predesign medium. The design boundary is designed by an interior region and a peripheral region. The item positions interior region of the design boundary. The template surface may include at least one horizontal line and at least one vertical line that enables aligned positioning and fastening of the item.

Thus, the item is positioned inside an interior region of the design boundary, and then aligned along the vertical and horizontal lines, as desired. After fastening the items on the template surface, the template surface may then be mounted on a more durable mounting surface. The mounting surface may include a leveling line that enables appropriate alignment and mounting of the template surface. A frame may also be aligned by the horizontal and vertical lines to enable enclosure of the item on the template surface.

In some embodiments, a collage system for predesign and arrangement of items on a surface is used to systematically design a collage on a selected predesign medium, such as a display screen through software, and then arrange the predesigned collage on a template surface, such as a prefabricated panel, before mounting the completed collage on a mounting surface.

The collage system may include a plurality of predesign mediums. The predesign mediums may be displayed on a display screen. One of the predesign mediums is selected. The collage may further include at least one design boundary that is defined by an interior region and a peripheral region. The at least one design boundary configured to display in one of the plurality of predesign media. The design boundary may be manipulated to change the dimensions and positon on the predesign medium.

In some embodiments, the selected predesign medium is converted to a template surface. The template surface is configured to substantially match the plurality of predesign mediums. The template surface has substantially the same arrangement for the at least one design boundary as the one predesign medium. In essence, the size and positon of the design boundary on the template surface is substantially identical to the predesign medium. The template surface comprising at least one vertical line and at least one horizontal line for enabling alignment of at least one item.

In some embodiments, the collage system comprises a mounting surface configured to enable mounting of the template surface. The mounting surface comprising a leveling line that enables the template surface to be aligned evenly on the mounting surface, relative to the leveling line. Once the template surface is mounted on the mounting surface, at least one item may be fastened in the interior region of the design boundary. The item may be aligned with on the template surface through use of the at least one vertical line and the at least one horizontal line that traverse the template surface.

In some embodiments, the collage system may utilize a frame. The frame is configured to enclose a predetermined region around the at least one item. In other embodiments, at least one projecting member extends from the mounting surface. The projecting member is disposed to align along the at least one horizontal line and the at least one vertical line of the template surface. The projecting member configured to enable support of a shelf

In one embodiment of the present invention, a method for creative arrangement of items on a surface to form a decorative layout, comprises an initial Step of providing a plurality of predesign media. A Step may include selecting one of the plurality of predesign media.

The method may include a further Step of providing at least one design boundary, the at least one design boundary defined by an interior region and a peripheral region. A Step includes manipulating a dimension of the at least one design boundary in relation to the selected predesign medium. A Step comprises manipulating a position of the at least one design boundary in relation to the selected predesign medium.

A Step comprises converting the selected predesign medium to a template surface, the template surface having substantially the same arrangement for the at least one design boundary as the selected predesign medium, the template surface comprising at least one vertical line and at least one horizontal line. In some embodiments, a Step may include positioning the template surface on a mounting surface, the mounting surface comprising a leveling line. Another Step in the method comprises aligning, generally, the template surface with the leveling line of the mounting surface.

Yet another Step includes arranging at least one item approximately in the interior region of the at least one design boundary. A Step may include aligning, generally, the at least one item with the at least one vertical line and the at least one horizontal line of the template surface. In some embodiments, a Step may include fastening the at least one item to the template surface. Another Step includes providing a frame, the frame configured to enclose a predetermined region around the at least one item. A final Step may include enclosing the predetermined region around the at least one item with the frame.

In a second aspect, method includes a software application. In another aspect, the positions and dimensions of at least one design boundary on predesign medium are predesigned from a display screen. In another aspect, design boundary is dragged across predesign medium on the display screen to a desired position on predesign medium.

In another aspect, design boundary may be arranged, rearranged, and added by dragging design boundaries around the display screen, by using a rearrange button, or by manipulation of any other buttons on the display screen.

In another aspect, predesign medium is a prefabricated panel with an outline of design boundary, wherein at least one design boundary has at least one vertical line and at least one horizontal line. In another aspect, mounting surface is a wall in a building. In another aspect, leveling line on mounting surface is a horizontal line that aligns with a top edge of perimeter on predesign medium. In another aspect, predesign medium is taped to mounting surface.

In another aspect, at least one vertical line is centrally disposed on the predesign medium. In another aspect, at least one horizontal line is a series of evenly spaced-apart lines on predesign medium. In another aspect, at least one design boundary is square or rectangular shaped. In another aspect, the frame is square or rectangular shaped, substantially the same as at least one design boundary.

One objective of the present invention is to create a collage with at least one image content, form, and art work in a level, accurate alignment.

Another objective is to provide a software application that enables predesign of a collage, including the types of image content, the dimensions of the frame, and the positioning of the frame.

Another objective is to provide a collage with at least one projecting member for supporting a shelf.

Another objective is to level predesign medium with a leveling line on mounting surface.

Another objective is to align frame against the centrally disposed vertical line, and the series of evenly spaced-apart horizontal lines.

Another objective is to provide an easy to operate software application to design and manufacture a collage.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings

### BRIEF DESCRIPTION OF THE DRAWINGS

The invention will now be described, by way of example, with reference to the accompanying drawings, in which:

FIG. 1 illustrates a front view of an exemplary collage system and method for creative predesign and arrangement of items on a surface, in accordance with an embodiment of the present invention;

FIG. 2 illustrates a front view of a screenshot on exemplary display screen, showing an exemplary predesign setting member, in accordance with an embodiment of the present invention;

FIG. 3 illustrates a front view of a screenshot on an exemplary display screen, in accordance with an embodiment of the present invention;

FIG. 4 illustrates a front view of a screenshot on a display screen, showing an exemplary design boundary, in accordance with an embodiment of the present invention;

FIG. 5 illustrates a front view of a screenshot on a display screen, showing a design boundary having an exemplary image, in accordance with an embodiment of the present invention;

FIG. 6 illustrates a front view of a screenshot on a display screen, showing two design boundaries, each having an image, in accordance with an embodiment of the present invention;

FIG. 7 illustrates a front view of a screenshot on a display screen, showing two design boundaries, each having an image, and additional design boundaries without images, in accordance with an embodiment of the present invention;

FIG. 8 illustrates a front view of a screenshot on a display screen, showing a central design boundary having an image and a smaller adjacent design boundary having an image, in accordance with an embodiment of the present invention;

FIG. 9 illustrates a front view of a screenshot on a display screen, showing a central design boundary having an image and a smaller adjacent design boundary having an image shown in FIG. 8, where the smaller design boundary is moved down, in accordance with an embodiment of the present invention;

FIG. 10 illustrates a front view of a screenshot on a display screen, showing a central design boundary having an image and a smaller adjacent design boundary having an image shown in FIG. 8, where the smaller design boundary is moved beneath the large design boundary, in accordance with an embodiment of the present invention;

FIG. 11 illustrates a front view of an exemplary template surface, in accordance with an embodiment of the present invention;

FIG. 12 illustrates a perspective view of a template surface and at least one item positioned for mounting on a respective design boundary, in accordance with an embodiment of the present invention;

FIG. 13 illustrates a perspective view of an exemplary template surface mounted on an exemplary mounting surface, in accordance with an embodiment of the present invention; and

FIGS. 14A and 14B illustrate a flowchart showing an exemplary method for predesign and arrangement of at least one item on a surface, in accordance with an embodiment of the present invention.

Like reference numerals refer to like parts throughout the various views of the drawings.

### DETAILED DESCRIPTION OF THE INVENTION

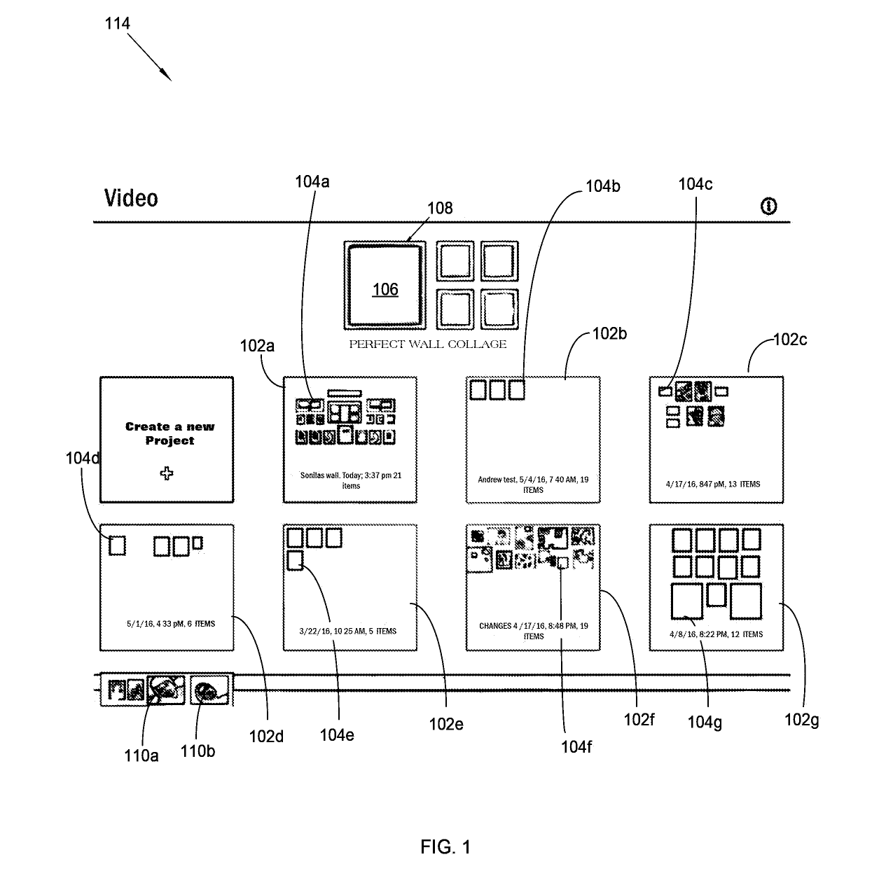

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A collage system 100 and method 200 for predesign and arrangement of items on a surface is referenced in FIGS. 1-14B. The collage system 100 and method 200 enables systematic predesign of a collage after being predesigned from a plurality of predesign media 102a-g. At least one design boundary 104a-g is manipulated on predesign media 102a-g until an arrangement of design boundaries 104a-g is manipulated to form the desired collage or decorative design. In this manner, a predesigned collage, or other decorative overlay, is conceptualized before actually being formed.

Thereafter, predesign medium 102a is converted to a template surface 120. Template surface 120 may include a non-digital, physical substrate. At least one item 126a-e may be attached to template surface 120 in conformance to the design of a selected predesign medium 102a. Item 126a-e may include decorative members that can be arranged in a pleasing relationship to each other upon a background material. Item 126a-e may be enclosed by at least one frame 132a, 132b for visual enhancement. Template surface 120 may be mounted on a mounting surface 128.

As referenced in FIG. 1, collage system 100 enables creative predesign of a collage through a predesign medium 102a, conversion of predesign medium 102a to a template surface 120, and subsequent arrangement of item 126a-e on template surface 120 to form the desired collage, or other decorative layout. Collage system 100 may provide a plurality of predesign media 102a-g that have various appearances and designs. One of the predesign media 102a-g may be selected for predesigning the collage, and subsequent conversion to a matching template surface 120.

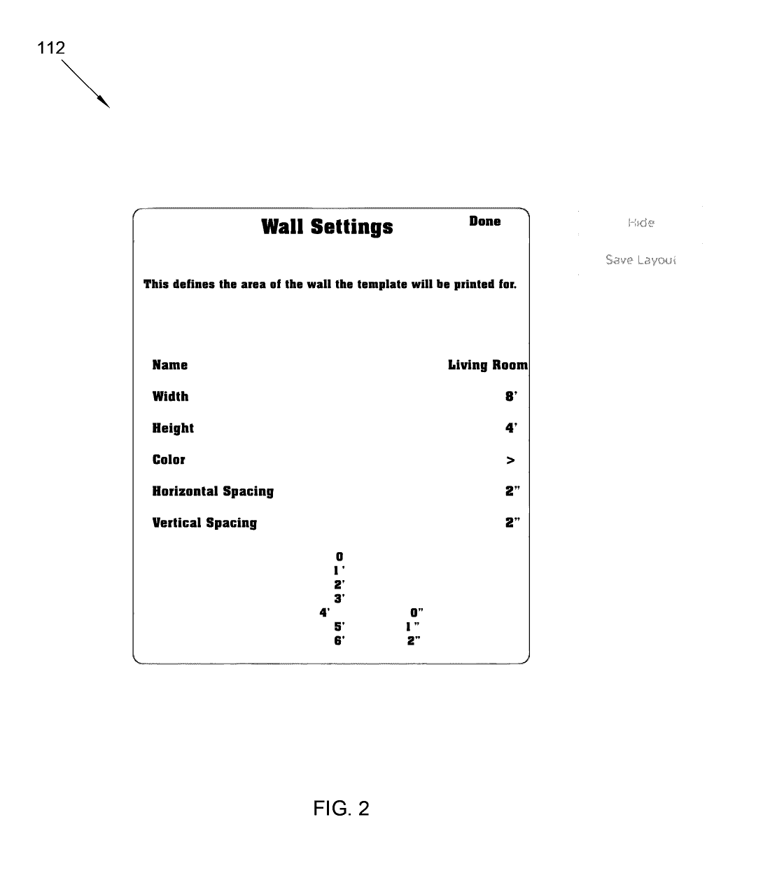

In some embodiments, a predesign setting member 112, shown in FIG. 2, may be used to set the dimensions and positions of a selected predesign media 102a, design boundary 104a-g, and template surface 120, as described below. The dimensions and position of design boundary 104a-g may be manipulated on predesign medium 102a. Design boundary is essentially the place holder for the at least one item 126a-e. Predesign medium 102a is selected and adjusted through predesign setting member 112.

The selected predesign medium 102a may be converted into a substantially matching template surface 120. Template surface 120, which may include a physical substrate, may be marked to have design boundary 104a-g that substantially matches design boundary 104a-g dimensioned and positioned in predesign medium 102a, i.e., digitally. Further, template surface 120 may include at least one horizontal line 124 and at least one vertical line 122 that enables aligned positioning and fastening of at least one item 126a-e inside an interior region 106 of design boundary 104a-g.

Thus, item 126a-e is positioned inside interior region 106 of design boundary 104a-g for displaying on template surface 120, and then aligned along the vertical and horizontal lines 122, 124 of template surface 120. For example, after mounting item 126a-e to template surface 120, the template surface 120 is mounted on a more durable mounting surface 128. Mounting surface 128 may include a leveling line 130 that enables appropriate alignment and mounting of the template surface 120. At least one frame 132a, 132b may also be aligned by horizontal and vertical lines 122, 124 to enable enclosure and visual enhancement of item 126a-e while displayed on template surface 120.

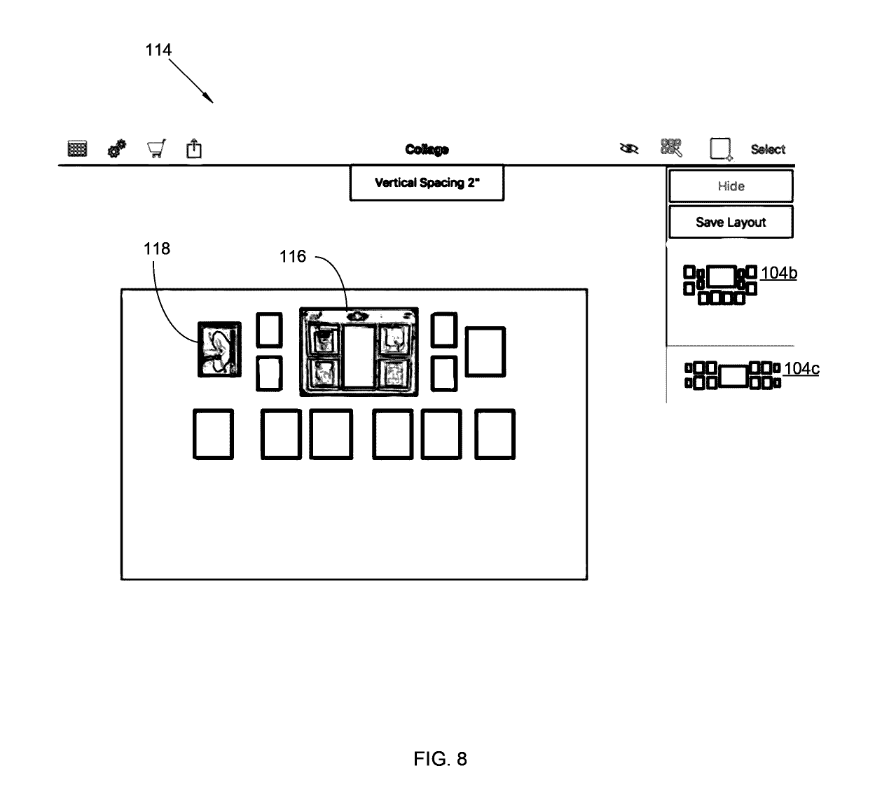

Looking forward to FIG. 8, collage system 100 may include a plurality of predesign media 102a-g. Predesign media 102a-g enables creative designing and flexibility for designing a collage. In one embodiment, predesign medium 102a is a rectangle shape and has one large, centrally positioned design boundary. In another embodiment, predesign medium 102b is square-shaped and is surrounded by twelve design boundaries—four to the left, four to the right, and four beneath (FIG. 8). In another embodiment, predesign medium 102cis square-shaped and is surrounded by twelve design boundaries—six to the left, and six to the right (FIG. 8). In another embodiment, predesign medium 102d is square-shaped and has a large design media with an image and four design media beneath.

In yet another example of the various possible designs, predesign medium 102e is square-shaped and has three design boundaries with images. In another embodiment, predesign medium 102f is square-shaped and has nine design boundaries. In another embodiment, predesign medium 102g is square-shaped and has ten boundaries above a central design boundary. Though in other embodiments, predesign media 102a-g may take any shape and position. Further, predesign media 102a-g and design boundary 104a-g are dimension and position adjustable, as described below. After achieving a desired design medium 102a, selection and saving of design medium 102a is possible.

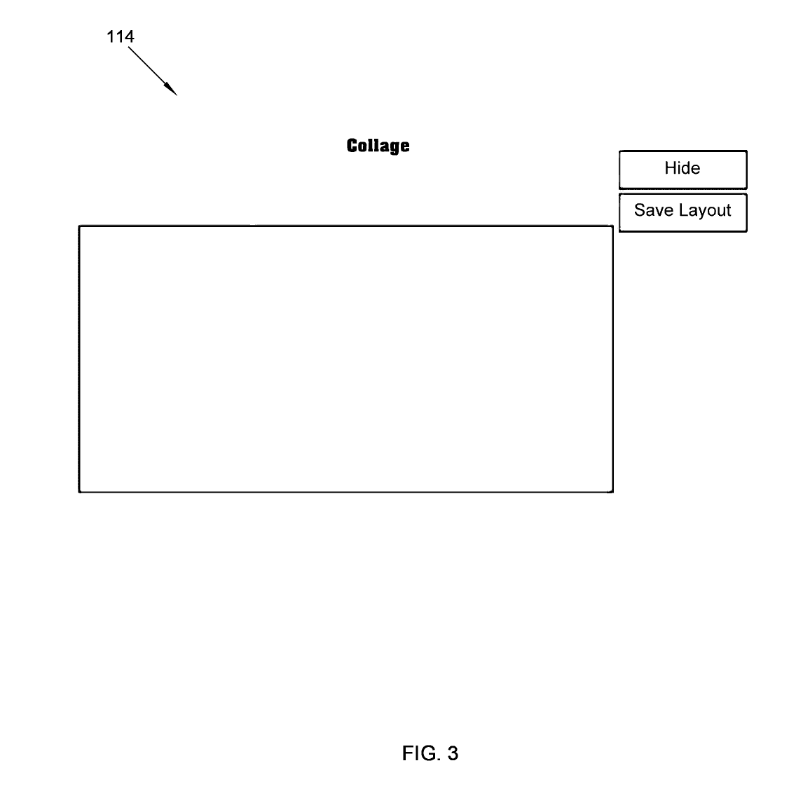

As discussed above and illustrated in FIG. 3, predesign media 102a-g may be displayed on a display screen 114. Display screen 114 may be from a computer, a tablet, or a smartphone. However in other embodiments, display screen 114 may include, without limitation, a computer monitor, a white board, and a digital board. In one embodiment, a software application may be used to access and operate predesign media 102a-g from display screen 114.

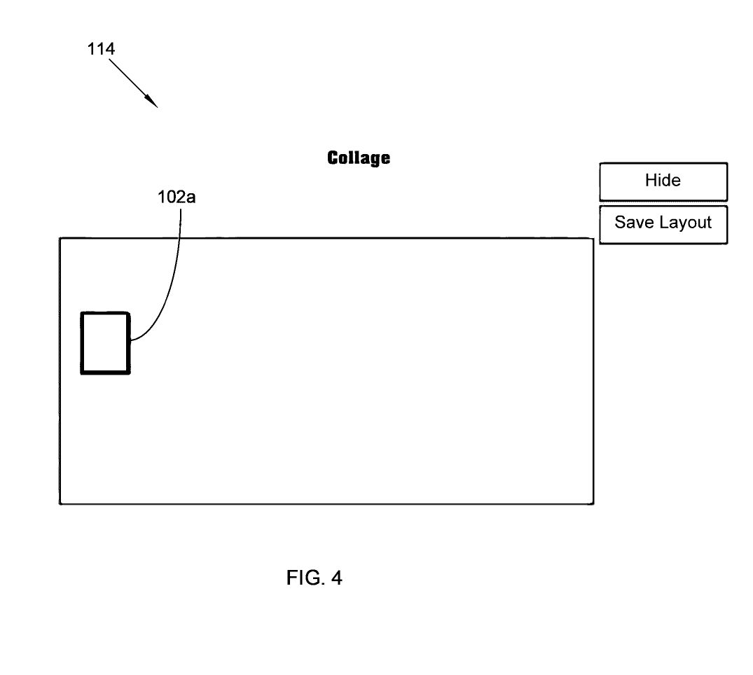

As discussed above, a single predesign medium 102a is selected from the plurality of predesign media 102a-g. As FIG. 4 shows, plurality of predesign media 102a-g may be visible on the display screen 114. One of predesign media 102a-g is selected, based on preference and need of finished collage. The selection may be between various template-style arrangements of size and placement of at least one design boundary 104a-g in relation to each other. This selection is determinative of subsequent design of template surface 120, and positioning of at least one item 126a-e on template surface 120.

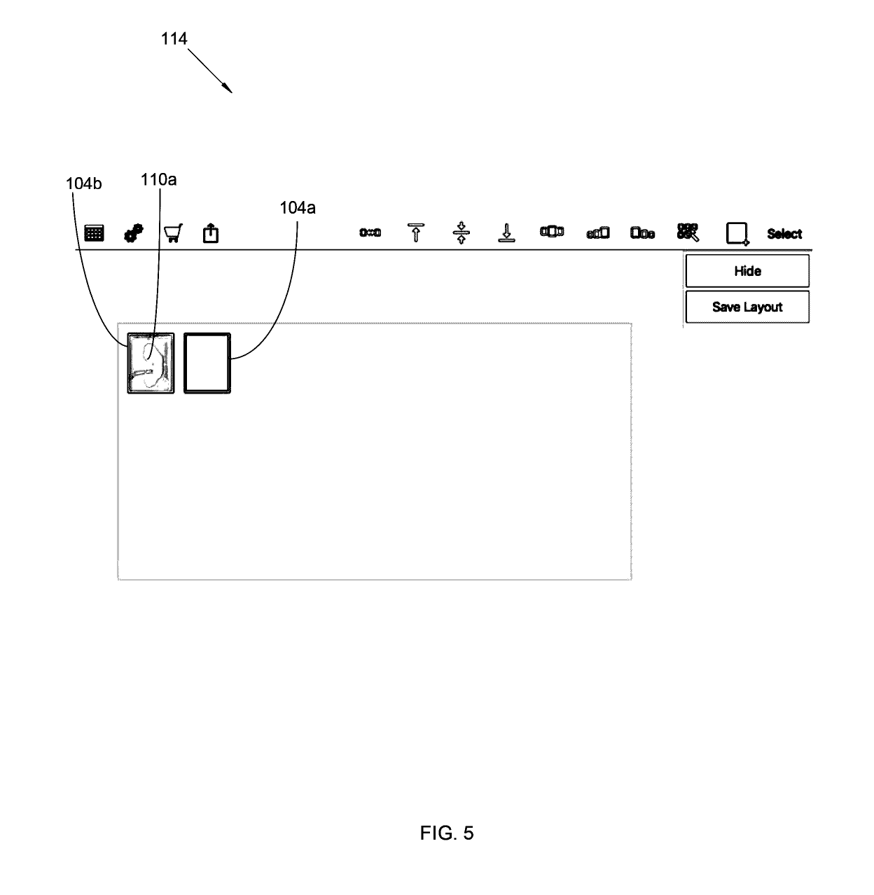

As discussed above and shown in FIG. 5, predesign media 102a-g may be populated by at least one design boundary 104a-g. Design boundary 104a-g is configured to display for selection in predesign medium 102a. In one embodiment, design boundary 104a-g is defined by an interior region 106 and a peripheral region 108. Interior region 106 represents an area where at least one item 126a-e may subsequently be positioned. Thus, design boundary provides a visual as to where the items 126a-e subsequently appear on the finished collage. Suitable shapes for the design boundary 104a-g may include, without limitation, a rectangle, a square, a circle, an oval, and a triangle.

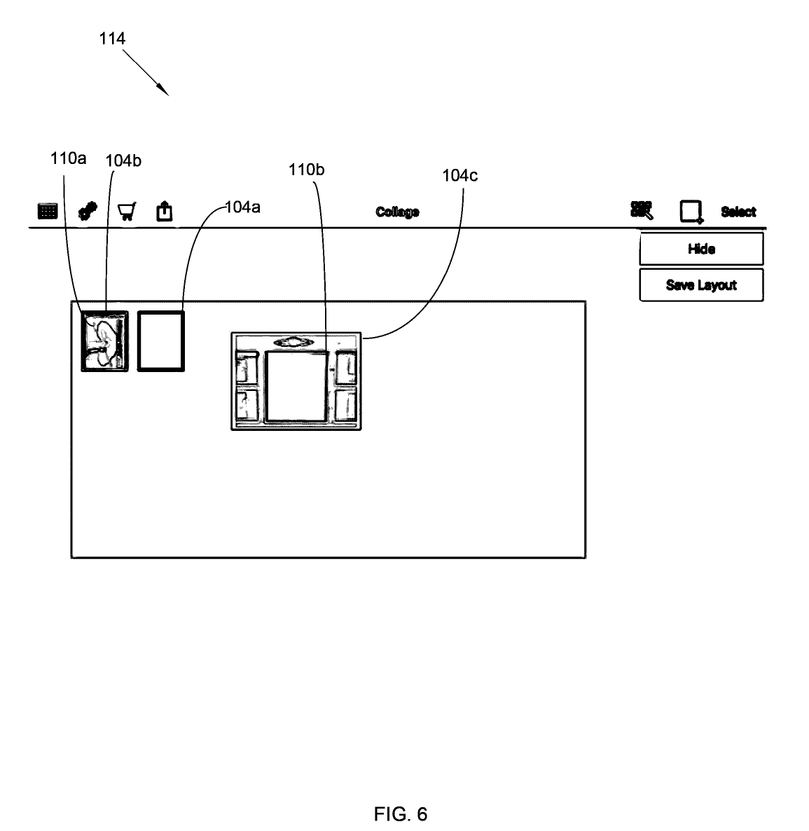

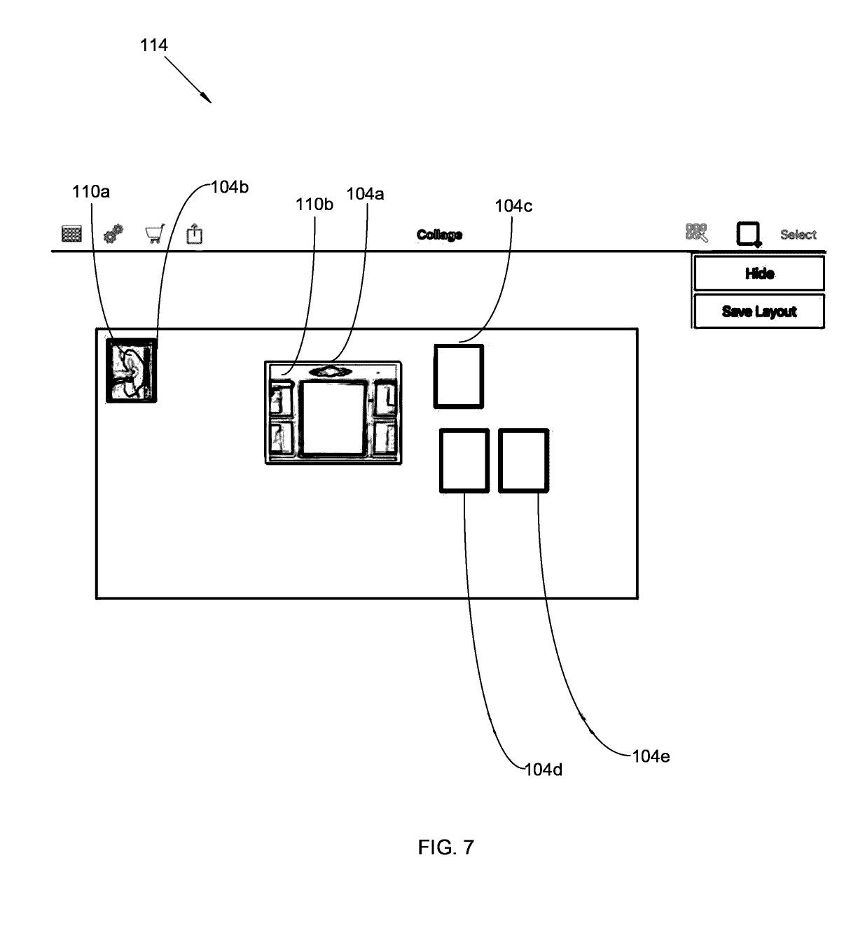

In one embodiment, at least one image 110a, 110b is selected to display from design boundary 104a-g. Image 110a, 110b is representative and provides a visual predesign of the item 126a-e that will be subsequently positioned at that space in the interior region 106 of the design boundary 104a-g. Use of the image 110a, 110b in the design boundary 104a-g during predesign of the predesign medium is illustrated in FIGS. 6 and 7.

In one example, design boundary 104a is square shaped. In another example, design boundary 104b is rectangular shaped. In another example, design boundary 104c is oval shaped. In another example, design boundary 104d is square shaped and has an image 110a of a face. In another example, design boundary 104e is rectangular shape and has an image 110b of a letter. In another example, design boundary 104f overlaps design boundary 104g. Further design boundary 104a-g may be dimension and positon adjusted.

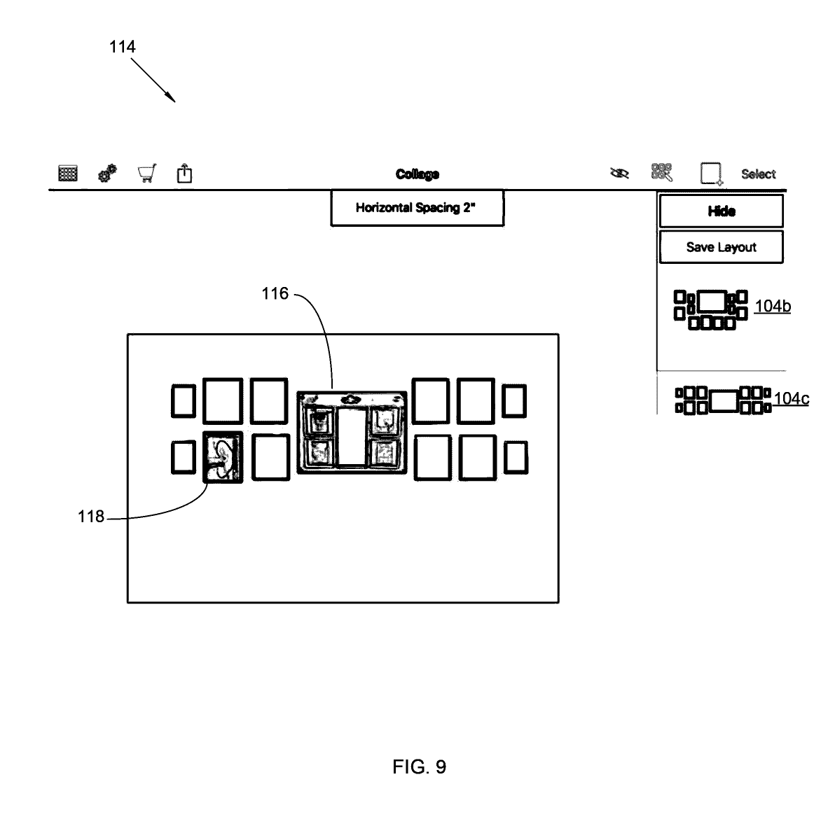

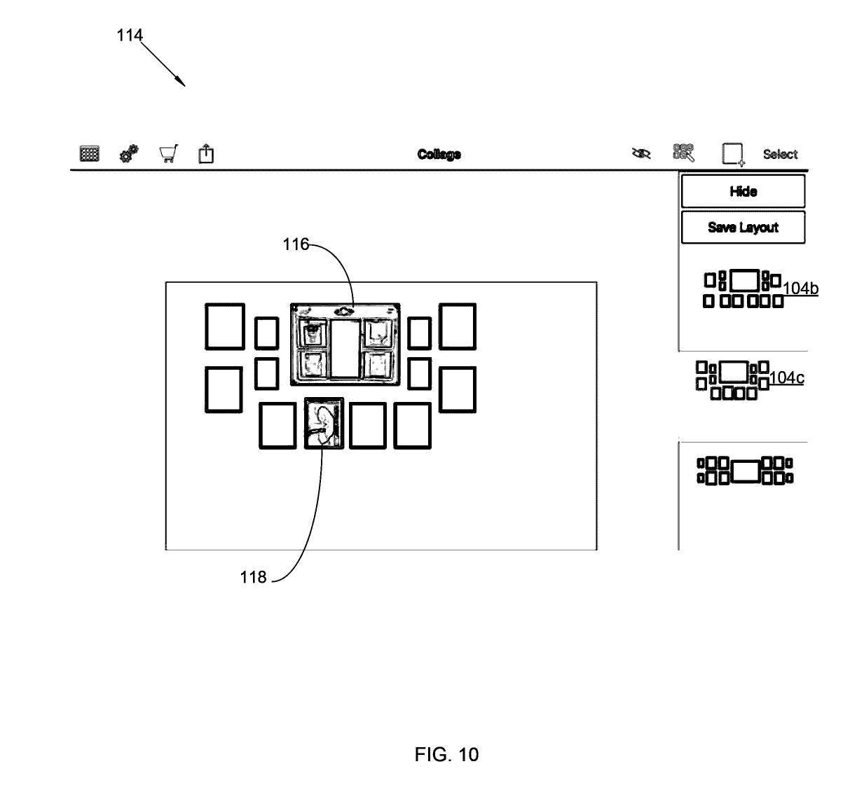

Further, design boundary 104a-g may be manipulated to change its dimensions and/or position relative to the predesign medium. FIGS. 8-10 illustrate such a manipulation of position for a small design boundary 118. FIG. 8 illustrates a large, centrally positioned design boundary 116 with an image 110a contained in its interior region 106, and multiple smaller design boundaries surrounding, including a small design boundary 118 having an image 110b. Any of these design boundaries 116, 118 may be moved in relation to each other and their sizes and shapes altered, as desired. For example, FIG. 9 illustrates the small design boundary 118 having an image 110b positioned adjacently to the central design boundary 116 having an image 110a. After some drag-and-drop manipulations, FIG. 10 illustrates the small design boundary 118 moved beneath the central design boundary 116.

Looking back at FIG. 7, in altering the dimensions and positions of design boundaries 104a-g and image 110a, 110b contained therein, may be performed through computer drag and drop functions known in the computer art. In one embodiment, design boundary 104a is dragged across predesign medium, such as a display screen to a desired position on predesign medium. In another embodiment, design boundary 104a may be arranged, rearranged, and added by dragging design boundaries around the display screen, by using a rearrange button, or by manipulation of any other buttons on the display screen. Once, design boundary 104a is dimensioned and positioned to a desired configuration, the selected predesign medium configuration may then be saved.

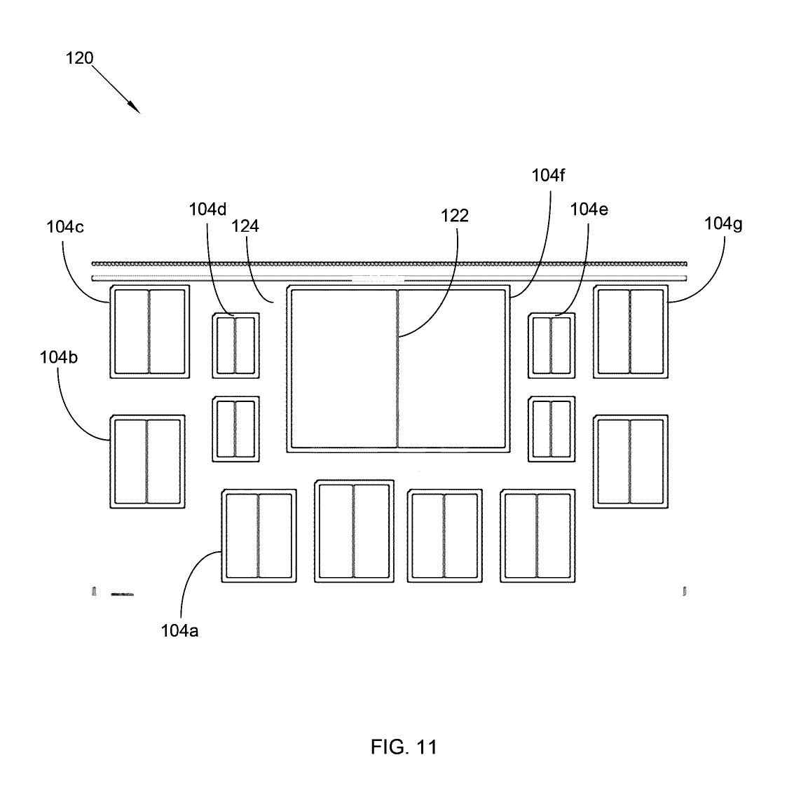

Turning now to FIG. 11, selected predesign medium 102a is converted to a template surface 120. Template surface 120 is configured, chiefly to enable positioning of the at least one item 126a-e, thereon. Predesign setting member 112, described above, may be used to match dimensions of predesign medium 102a with template surface 120. For example, as shown in FIG. 2, a name of a room, a height of design boundary 104a, a width of design boundary 104a, a color of image 110a, a horizontal spacing of template surface 120, and a vertical spacing of template surface 120 may be controlled during predesign in predesign setting member 112. In this manner, template surface 120 may be shaped as a square, a rectangle, a pyramid, or an oval. However, in other embodiments, other shapes may be used. Suitable materials for template surface 120 may include, without limitation, paper, vinyl, nylon, leather, bamboo, chalkboard, drywall, and metal.

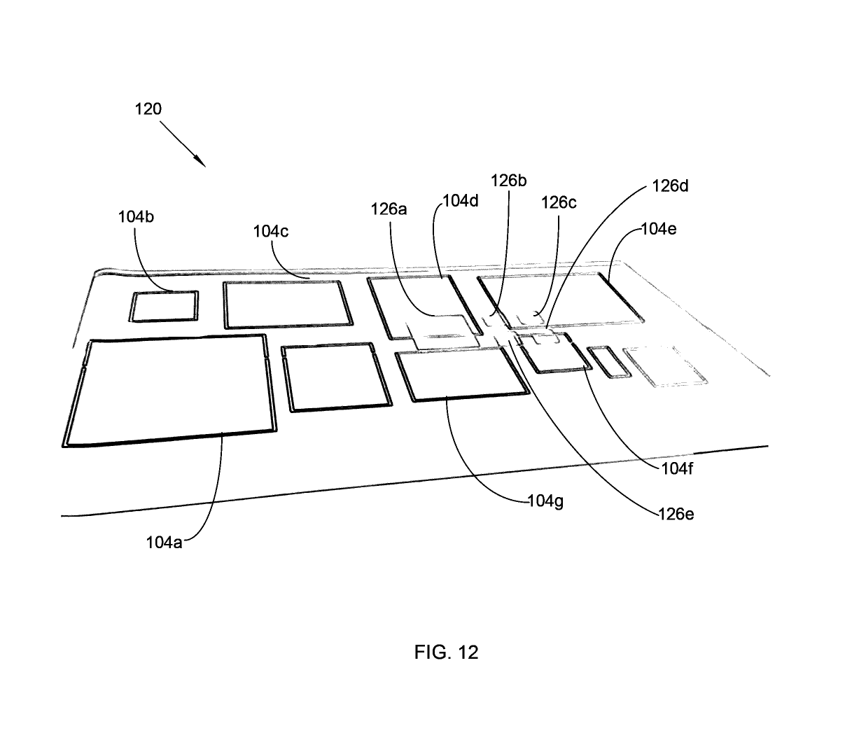

The conversion of the selected predesign medium 102a to template surface 120 may include printing the completed predesign medium 102a and the arrangement of design boundaries 104a-g. As comparison of FIGS. 10 and 12 shows, the template surface 120 is configured to substantially match the selected predesign medium 102a. Further, template surface 120 has substantially the same arrangement of design boundaries 104a-g as the selected predesign medium 102a.

In essence, the size and positon of design boundary 104a-g on template surface 120 is substantially identical to predesign medium 102a. Thus, in one exemplary embodiment, a digital image 110a, 110b of predesign medium 102a is printed on a paper substrate composition of template surface 120, in substantially the same dimensions, and with the design boundaries 104a-g substantially sized and positioned the same.

As FIG. 11 illustrates, template surface 120 is configured, chiefly to enable positioning of the at least one item 126a-e, thereon. Template surface 120 may include at least one vertical line 122 and at least one horizontal line 124 for enabling alignment of the item 126a-e. For example, item 126a-e can be leveled horizontally without tilting based on a straight horizontal line 124 on template surface 120.

Lines 122, 124 may include, without limitation, a single, centrally disposed vertical line 122; and a plurality of evenly spaced-apart horizontal lines. Though, in other embodiments, diagonal lines may also be used, depending on the dimensions of design boundary 104a-g. Lines 122, 124 enable precise alignment of frame 132a, 132b that encloses item design boundary 104a-g and displays the selected image 110a, 110b content. Vertical and horizontal lines 122, 124 are also used to align a projecting member 134 for supporting a shelf, as described below.

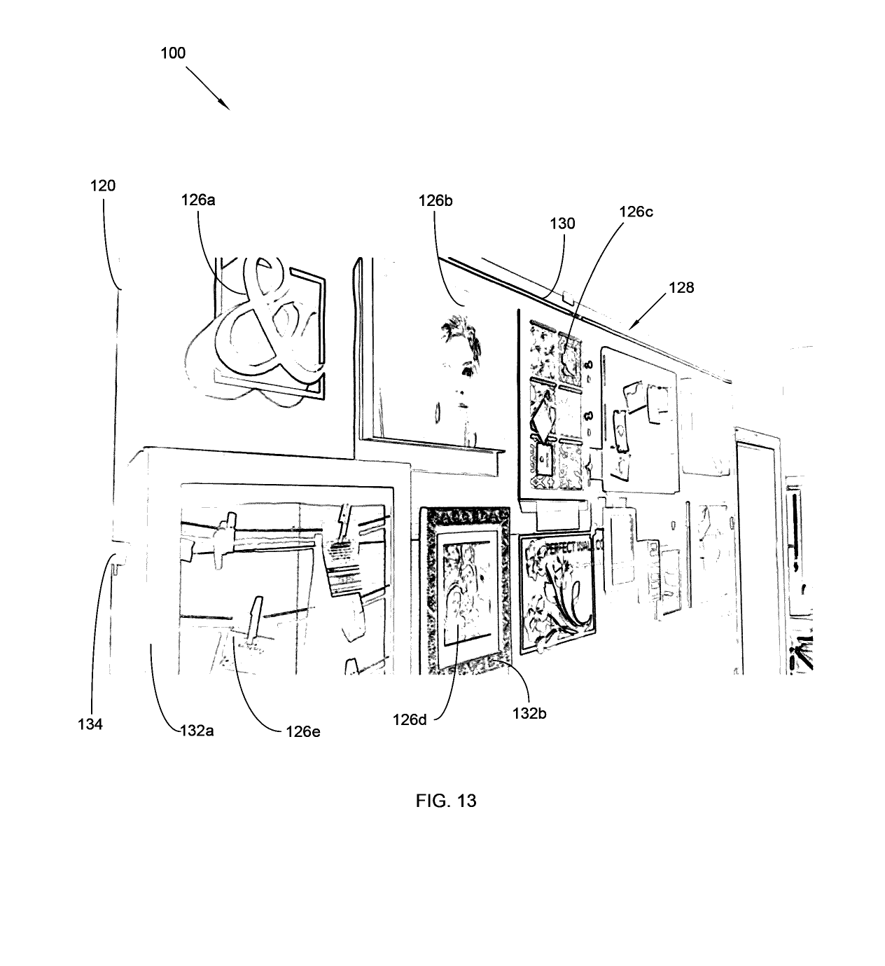

Looking now at FIG. 13, collage system 100 comprises a mounting surface 128 configured to enable mounting of the template surface 120. Mounting surface 128 comprises a leveling line 130 that enables template surface 120 to be aligned evenly on mounting surface 128, relative to leveling line 130. Once template surface 120 is mounted on mounting surface 128, item 126a-e may be fastened in the interior region 106 of the design boundary 104a-g. Item 126a-e may be aligned with on the template surface 120 through use of the at least one vertical line 122 and the at least one horizontal line 124 that traverse template surface 120.

As FIG. 13 shows, item 126a may include a block letter. Item 126b may also include a portrait. Item 126c may also include abstract art. Item 126d may also include an oil painting. Item 126e may also include assortment of metal and plastic members assembled into artwork. Through in other embodiments, item 126a-e may include any object can be assembled to form a collage or decorative outlay.

In some embodiments, collage system 100 may utilize at least one frame 132a, 132b. Frame 132a, 132b is configured to enclose a predetermined region around item 126a-e. In some embodiments, frame 132a, 132b may then be designed to substantially match the dimensions of predesigned design boundary 104a-g. Frame 132a, 132b displays the same image 110a, 110b, and has substantially the same dimensions as design boundary 104a-g. Frame 132a, 132b overlays the peripheral region 108 of design boundary 104a-g. Frame 132a, 132b detachably attaches thereto for enhanced visual appearance. In one embodiment, frame 132a, 132b is a picture frame. Frame 132a, 132b may be manufactured to have the same size and dimensions of design boundary 104a designed on the software application in design medium 102a.

Looking back at FIG. 11, vertical and horizontal line 122, 124 on predesign medium 102a enable precise alignment of frame 132a, 132b in relation to design boundary 104a-g. For example, vertical line 122 may include a single, centrally disposed line that signifies the center of template surface 120. Frame 132a, 132b may be shifted laterally to overlay the respective design boundary 104a-g. Horizontal line 124 may include a series of evenly spaced-apart lines that align surface template even with mounting surface 128, the ground, or the ceiling. Once substantially covering design boundary 104a-g, frame 132a, 132b may be tilted to become flush with the selected horizontal line 124. Or in other embodiments, frame 132a, 132b may be raised and lowered to achieve a desired elevation on predesign medium 102a.

As illustrated in FIG. 13, at least one projecting member 134 extends from mounting surface 128. Projecting member 134 is disposed to align along the at least one horizontal line 124 and vertical line 122 of template surface 120. Projecting member 134 enables support of a shelf. In some embodiments, vertical and horizontal line 122,124 may also be used to orient and position projecting member 134 to more effectively support shelf on mounting surface 128.

In some embodiments, projecting member 134 may include a bracket, a ridge, or a slot that is sized and dimensioned to carry and support the weight of a shelf. Projecting member 134 is aligned at a desired elevation by selecting the appropriate horizontal line 124. Projecting member 134 is aligned at a desired lateral position by shifting relative to the centrally disposed vertical line 122.

In one alternative embodiment, the position of projecting member 134 may be predesigned and marked on the template surface 120 with design boundary 104a. In this manner, template surface 120 is effective for facilitating the precise alignment and juxtaposition of different component items 126a-e, forms, artwork, and projecting members 134 to create a collage that forms an overall new whole.

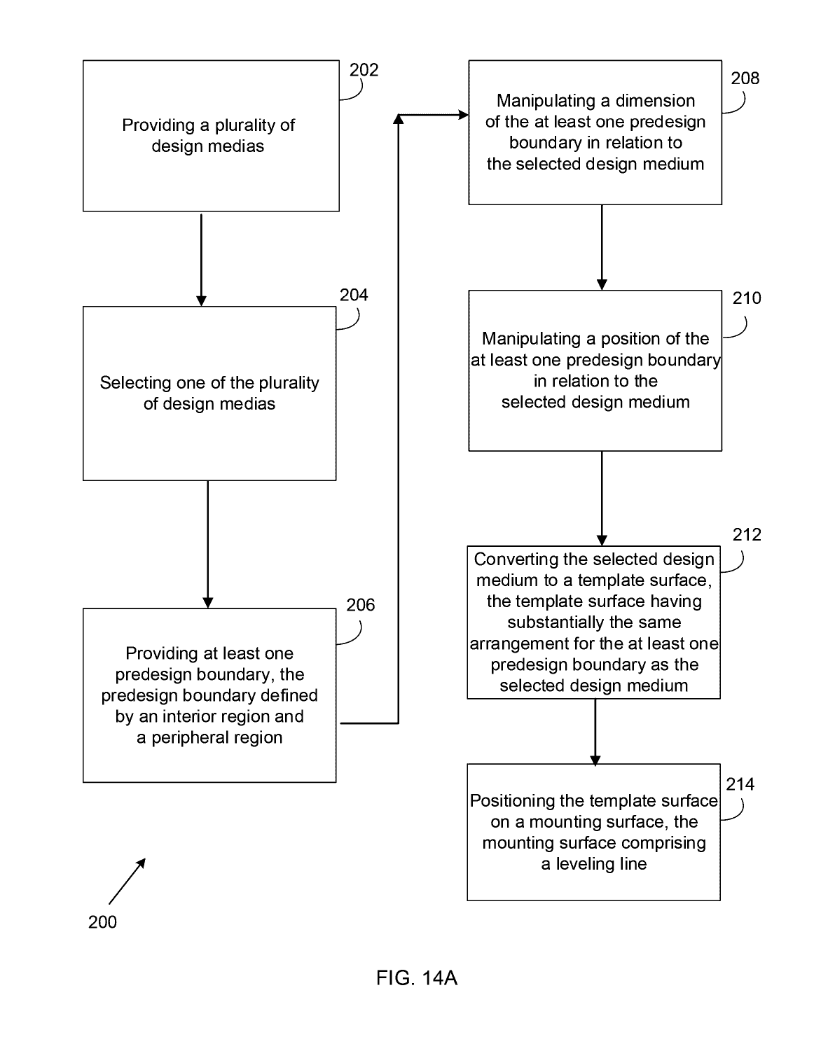

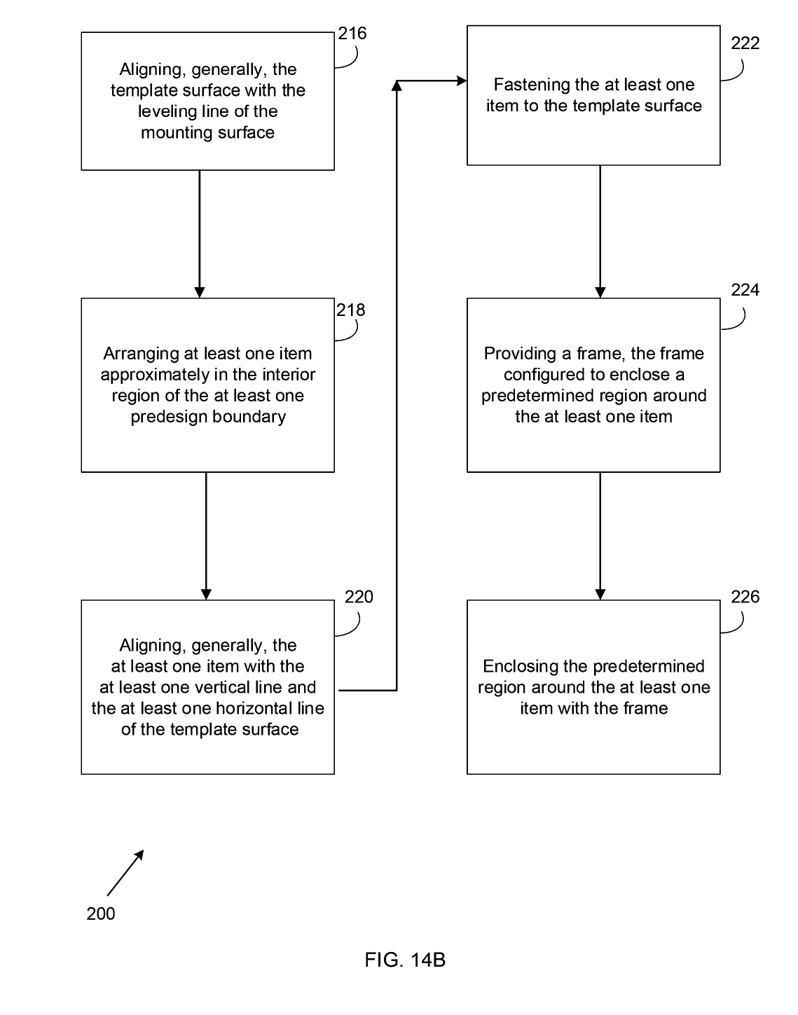

FIGS. 14A and 14B illustrate a flowchart showing an exemplary method 200 for predesign and arrangement of at least one item 126a-e on a surface. The method 200 comprises an initial Step 202 of providing a plurality of predesign media 102a-g. Predesign media 102a-g enables creative designing and flexibility for designing a collage. In one embodiment, predesign medium 102a is a rectangle shape and has one large design boundary. As discussed above and illustrated in FIG. 3, predesign media 102a-g may be displayed on a display screen 114.

A Step 204 may include selecting one of the plurality of predesign media 102a-g. A single predesign medium 102a is selected from the plurality of predesign media 102a-g. As FIG. 4 shows, a plurality of predesign media 102a-g may be visible on the display screen 114. One of the predesign medium is selected, based on preference.

The method 200 may include a further Step 206 of providing at least one design boundary 104a-g, the at least one design boundary 104a-g defined by an interior region 106 and a peripheral region 108. The selection may be between various template-style arrangements of size and placement of at least one design boundary 104a-g in relation to each other. This selection is determinative of subsequent design of template surface 120, and positioning of at least one item 126a-e on template surface 120.

A Step 208 includes manipulating a dimension of the at least one design boundary 104a-g in relation to the selected predesign medium. A Step 210 comprises manipulating a position of the at least one design boundary 104a-g in relation to the selected predesign medium. In altering the dimensions and positions of design boundaries 104a-g and image 110a, 110b contained therein, may be performed through computer drag and drop functions known in the computer art.

A Step 212 comprises converting the selected predesign medium to a template surface 120, the template surface 120 having substantially the same arrangement for the at least one design boundary 104a-g as the selected predesign medium, the template surface 120 comprising at least one vertical line 122 and at least one horizontal line 124. The conversion of the selected predesign medium 102a to template surface 120 may include printing the completed predesign medium 102a and the arrangement of design boundaries 104a-g. As comparison of FIGS. 10 and 12 shows, the template surface 120 is configured to substantially match the selected predesign medium 102a. Further, template surface 120 has substantially the same arrangement of design boundaries 104a-g as the selected predesign medium 102a. In essence, the size and positon of design boundary 104a-g on template surface 120 is substantially identical to predesign medium 102a.

In some embodiments, a Step 214 may include positioning the template surface 120 on a mounting surface 128, the mounting surface 128 comprising a leveling line 130. Another Step 216 in the method 200 comprises aligning, generally, the template surface 120 with the leveling line 130 of the mounting surface 128. Mounting surface 128 comprises a leveling line 130 that enables template surface 120 to be aligned evenly on mounting surface 128, relative to leveling line 130. Once template surface 120 is mounted on mounting surface 128, item 126a-e may be fastened in the interior region 106 of the design boundary 104a-g.

Yet another Step 218 includes arranging at least one item 126a-e approximately in the interior region 106 of the at least one design boundary 104a-g. A Step 220 may include aligning, generally, the at least one item 126a-e with the at least one vertical line 122 and the at least one horizontal line 124 of the template surface 120. Item 126a-e may be aligned with on the template surface 120 through use of the at least one vertical line 122 and the at least one horizontal line 124 that traverse the template surface 120. In some embodiments, a Step 222 may include fastening the at least one item 126a-e to the template surface 120. Various fasteners may be used, including glue, screws, nails, magnets, and friction fit mechanisms.

Another Step 224 includes providing a frame 132a, 132b, the frame 132a, 132b configured to enclose a predetermined region around the at least one item 126a-e. Frame 132a, 132b is configured to enclose a predetermined region around item 126a-e. A final Step 226 may include enclosing the predetermined region around the at least one item 126a-e with the frame 132a, 132b. In some embodiments, frame 132a, 132b may then be designed to substantially match the dimensions of predesigned design boundary 104a-g. Frame 132a, 132b displays the same image 110a, 110b, and has substantially the same dimensions as design boundary 104a-g. Frame 132a, 132b overlays the peripheral region 108 of design boundary 104a-g. Frame 132a, 132b detachably attaches thereto for enhanced visual appearance.

In an alternative embodiment, a further Step may include selecting an image 110a, 110b for display in the at least one design boundary 104a-g, the image 110a, 110b configured to replicate the at least one item 126a-e. In another alternative embodiment, a further Step may include saving the manipulated dimension and the manipulated position of the at least one design boundary 104a-g. In yet another alternative embodiment, a further Step may include providing at least one projecting member 134.

In another alternative embodiment of method 200, a Step may include aligning the at least one projecting member 134 with at least one of the following: the leveling line 130, the at least one horizontal line 124, and the at least one vertical line 122. In an alternative embodiment, a further Step may include fastening the at least one projecting member 134 to the mounting surface 128. In an alternative embodiment, a further Step may include positioning a shelf on the at least one projecting member.

In yet another alternative method of installing items on a wall via a predesign medium, either pre designed or custom designed. A first Step includes selecting an item 126a-e to install on a wall. The item may include, without limitation, an image, a shelf, a toy, an ornamental member, and a ribbon. The alternative method may further include a Step of providing a predesign medium that is defined by perimeter, at least one horizontal line, and at least one vertical line, the predesign medium configured to enable alignment of the item. In one embodiment, the predesign medium is a collage that can be either predesigned or custom designed. The predesigned predesign medium is often fabricated in a factory. The custom designed predesign medium can be previewed on a computer as a predesign medium before actual construction of the collage.

In some embodiments, a Step includes aligning the item 126a-e with the at least one horizontal line, and at least one vertical line on the predesign medium. The alignment helps achieve a desired orientation and ornamental effect. A Step may include altering a position of the image in relation to the predesign medium, wherein the dimension and position of the item 126a-e forms a collage. Item 126a-e may be dragged across the predesign medium to a desired position on predesign medium. Design boundary may be rotated and stretched to form the desired design in predesign medium. A final Step may further include fastening item 126a-e to the wall. Item 126a-e may be fastened through various means, including, without limitation, adhesives, nails, magnets, hook and loop fasteners, and frictional fits. Conversely, item 126a-e may be detached and replaced, such that interchangeability is possible.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for predesign and arrangement of at least one item on a surface, the method comprising:
providing a plurality of predesign media;
selecting one of the plurality of predesign media;
providing at least one design boundary, the at least one design boundary defined by an interior region and a peripheral region;
manipulating a dimension of the at least one design boundary in relation to the selected predesign medium;
manipulating a position of the at least one design boundary in relation to the selected predesign medium;
converting the selected predesign medium to a template surface, the template surface having substantially the same arrangement for the at least one design boundary as the selected predesign medium, the template surface comprising at least one vertical line and at least one horizontal line;
positioning the template surface on a mounting surface, the mounting surface comprising a leveling line;
aligning, generally, the template surface with the leveling line of the mounting surface;
arranging at least one item approximately in the interior region of the at least one design boundary;
aligning, generally, the at least one item with the at least one vertical line and the at least one horizontal line of the template surface;
fastening the at least one item to the template surface;
providing a frame, the frame configured to enclose a predetermined region around the at least one item; and
enclosing the predetermined region around the at least one item with the frame.

2. The method of claim 1, further including the step of selecting an image for display in the at least one design boundary, the image configured to replicate the at least one item.

3. The method of claim 1, further including the step of saving the manipulated dimension and the manipulated position of the at least one design boundary.

4. The method of claim 1, further including the step of providing at least one projecting member.

5. The method of claim 4, further including the step of aligning the at least one projecting member with at least one of the following: the leveling line, the at least one horizontal line, and the at least one vertical line.

6. The method of claim 5, further including the step of fastening the at least one projecting member to the mounting surface.

7. The method of claim 6, further including the step of positioning a shelf on the at least one projecting member.

8. The method of claim 1, wherein the method includes a software application.

9. The method of claim 1, wherein the position and dimensions of the at least one design boundary on the predesign medium is configured from a display screen.

10. The method of claim 1, wherein the template surface is a prefabricated panel defined by an outline of the at least one design boundary.

11. The method of claim 1, wherein the mounting surface is a wall in a building.

12. The method of claim 1, wherein the leveling line on the mounting surface is a horizontal line.

13. The method of claim 1, wherein the template surface is taped to the mounting surface.

14. The method of claim 1, wherein the at least one vertical line is centrally disposed on the template surface.

15. The method of claim 1, wherein the at least one horizontal line is a series of evenly spaced-apart lines on the template surface.

16. The method of claim 1, wherein the at least one design boundary has a generally square or rectangular shape.

17. The method of claim 16, wherein the frame has a generally square or rectangular shape that substantially matches the shape of the at least one design boundary.

18. A method for predesign and arrangement of at least one item on a surface, the method comprising:
providing a plurality of predesign media;
selecting one of the plurality of predesign media;
providing at least one design boundary, the at least one design boundary defined by an interior region and a peripheral region;
manipulating a dimension of the at least one design boundary in relation to the selected predesign medium;
manipulating a position of the at least one design boundary in relation to the selected predesign medium;
saving the manipulated dimension and the manipulated position of the at least one design boundary;
selecting an image for display in the at least one design boundary;
converting the selected predesign medium to a template surface, the template surface having substantially the same arrangement for the at least one design boundary as the
selected predesign medium, the template surface comprising at least one vertical line and at least one horizontal line;
positioning the template surface on a mounting surface, the mounting surface comprising a leveling line;
aligning, generally, the template surface with the leveling line of the mounting surface;
arranging at least one item approximately in the interior region of the at least one design boundary;
aligning, generally, the at least one item with the at least one vertical line and the at least one horizontal line of the template surface;
fastening the at least one item to the template surface;
providing a frame, the frame configured to enclose a predetermined region around the at least one item;
enclosing the predetermined region around the at least one item with the frame;
providing at least one projecting member;
aligning the at least one projecting member with at least one of the following: the leveling line, the at least one horizontal line, and the at least one vertical line; and
positioning a shelf on the at least one projecting member.

19. The method of claim 18, wherein the method includes a software application.

20. A collage system for predesign and arrangement of at least one item on a surface, the collage comprising:
a plurality of predesign mediums;
at least one design boundary, the at least one design boundary defined by an interior region and a peripheral region, the at least one design boundary configured to display in one of the plurality of predesign media;
a template surface, the template surface configured to substantially match the plurality of predesign mediums, the template surface having substantially the same arrangement for the at least one design boundary as the one predesign medium, the template surface comprising at least one vertical line and at least one horizontal line;
a mounting surface, the mounting surface comprising a leveling line, the mounting surface configured to receive the template surface in a generally aligned disposition relative to the leveling line;
at least one item, the at least one item configured to fasten in the interior region of the at least one design boundary on the template surface, the at least one item further configured to align with the at least one vertical line and the at least one horizontal line of the template surface; and
a frame, the frame configured to enclose a predetermined region around the at least one item.
at least one projecting member, the at least one projecting member configured to extend from the mounting surface, the at least one projecting member disposed to align along the at least one horizontal line and the at least one vertical line of the template surface, the at least one projecting member configured to enable support of a shelf.
